(19) United States
(12) Patent Application Publication
(10) Pub. No.: US 2025/0205814 A1
(43) Pub. Date: Jun. 26, 2025

(54) LASER MACHINING HEAD WITH A SCANNER UNIT OR A SCANNER ASSEMBLY

(71) Applicant: TRUMPF Werkzeugmaschinen SE + Co. KG, Ditzingen (DE)

(72) Inventors: Axel Paul, Ditzingen/Heimerdingen (DE); Tobias Klühspies, Korntal- Münchingen (DE)

(21) Appl. No.: 19/079,513

(22) Filed: Mar. 14, 2025

Related U.S. Application Data
(63) Continuation of application No. PCT/EP2023/075173, filed on Sep. 13, 2023.

(30) Foreign Application Priority Data
Sep. 16, 2022 (DE) 10 2022 123 731.1

(51) Int. Cl. B23K 26/082; B23K 26/38; G02B 26/08; G02B 26/10

(52) U.S. Cl. CPC B23K 26/082; G02B 26/0816; G02B 26/101; B23K 26/38

(57) ABSTRACT

A laser machining head includes a scanner. The scanner includes a mirror unit with a scanner mirror. The mirror unit has a groove that runs in a circumferential direction. The scanner further includes a frame capable of being secured in the laser machining head. The mirror unit is movably mounted in the frame. The scanner further includes an annular elastic seal secured to the frame on an outer circumference of the seal and engages with the groove on an inner circumference of the seal.

### CROSS REFERENCE TO RELATED APPLICATIONS

This application is a continuation of International Application No. PCT/EP2023/075173 (WO 2024/056745 A1), filed on Sep. 13, 2023, and claims benefit to German Patent Application No. DE 10 2022 123 731.1, filed on Sep. 16, 2022. The aforementioned applications are hereby incorporated by reference herein.

### FIELD

Embodiments of the present invention relate to the field of laser machining of workpieces, preferably the laser cutting of metallic workpieces. In particular, embodiments of the invention relate to a laser machining head, in particular a laser cutting head, with a scanner unit or a scanner assembly for dynamically deflecting a laser beam in the laser machining head.

### BACKGROUND

Scanner systems in which a laser beam is dynamically deflected within a laser machining head by a controlled tilting of one or more scanner mirrors are state of the art. For example, it is known to arrange a deflecting mirror in the collimated beam guidance area of the laser machining head, which can be tilted independently and dynamically about both transverse axes. The highly integrated design includes the mounted scanner mirror as a rotor assembly with four magnet pairs distributed around the circumference including an iron yoke. The rotor is suspended by four solid-state joint arms and is deflected or tilted around the initial position by four coils (stator) located opposite the magnets. During the movement of the scanner mirror, particle formation can occur, particularly due to abrasion between movable components of the assembly. To meet the cleanliness requirements in the laser machining head, which substantially do not allow any adhering contamination in the optical space, the semi-clean rear space of the scanner assembly must be effectively shielded from the optical space of the laser machining head.

From DE102016210698A1, an arrangement for EUV lithography is known, in which at least one reflective optical element is movably mounted in a housing, wherein a casing at least partially envelops the holder and the base body of the optical element and seals an actuator space from an optical space and wherein the casing has at least one flexible section to enable the movement of the optical element. The flexible section can be formed by a flexible plastic component. For fastening purposes, the casing can be glued to the base body or secured in a force-or form-fit manner, for example clamped with a spiral spring or a clamping ring.

WO2019145536A1 describes various variants of how a laser beam can be moved with high frequency and over a short distance within the nozzle of a laser machining head, e.g., with the help of a scanner mirror.

EP4000789A2 describes an optical device with a carrier and a scanner mirror movably secured thereto. A seal membrane forms an airtight connection between the scanner mirror and the carrier.

### SUMMARY

Embodiments of the present invention provide a laser machining head that includes a scanner. The scanner includes a mirror unit with a scanner mirror. The mirror unit has a groove that runs in a circumferential direction. The scanner further includes a frame capable of being secured in the laser machining head. The mirror unit is movably mounted in the frame. The scanner further includes an annular elastic seal secured to the frame on an outer circumference of the seal and engages with the groove on an inner circumference of the seal.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a laser cutting system for laser beam cutting in a schematic, perspective view according to some embodiments;

FIG. 2 shows a schematic representation of a laser cutting head according to some embodiments;

FIG. 3a shows a sectional view of a scanner assembly for a laser machining head according to some embodiments;

FIG. 3b shows an enlarged detail of the illustration according to FIG. 3a according to some embodiments; and

FIG. 3c shows another sectional representation of the scanner assembly according to FIG. 3a according to some embodiments.

### DETAILED DESCRIPTION

Embodiments of the present invention can provide an effective shielding of the optical space of a laser machining head from the actuator or drive space of a scanner unit or a scanner assembly. The aim is to minimize any influence on the movement dynamics of the scanner mirror. In particular, the suitability of existing scanner systems for use in multi-kilowatt laser cutting systems is to be improved.

Embodiments of the invention provide a laser machining head, in particular a laser cutting head, with a scanner unit in accordance with a first aspect. The scanner unit comprises a mirror unit with a scanner mirror, wherein the mirror unit has a groove which runs in the circumferential direction. The mirror unit can preferably have a mirror mount arranged on the outer circumference of the scanner mirror. The scanner mirror can preferably be firmly connected to the mirror mount, for example by an adhesive connection. The circumferential groove can then preferably be arranged on the outer circumference of the mirror mount.

As a rule, a laser machining head comprises at least one inlet opening for the laser beam, an optical space in which the laser beam is guided through the laser machining head by means of optical elements, in particular by means of lenses and/or mirrors, and an outlet opening for the laser beam to exit from the laser machining head. The scanner unit with the scanner mirror as the beam-guiding optical element is then arranged to be adjacent to the optical space of the laser machining head.

The scanner unit comprises a frame which can be secured in the laser machining head, wherein the mirror unit is movably mounted in the frame. In particular, the frame and the mirror unit can be arranged in a common plane of the scanner unit, wherein the frame surrounds the mirror unit in the lateral direction. The frame can in particular form a lateral housing for the scanner unit.

Furthermore, the scanner unit comprises an annular elastic seal element. The seal element is secured to the frame along the outer circumference of the seal element and engages the circumferential groove along the inner circumference of the seal element. The seal element is preferably flat.

The proposed solution allows a particularly compact and lightweight design of the scanner unit in the laser machining head. The seal element effectively seals the gap between the mirror unit and the frame against the passage of particles. Particles can be created by the relative movements of the mechanical components of the mirror suspension and a drive unit, which is preferably arranged between the frame and the mirror unit and which is designed to tilt the mirror unit. The seal element shields the optical space of the laser machining head from the movable drive components of the scanner unit, thus lessening the certainty of optical failure due to contamination. The seal also makes it possible to apply a cooling gas to the mirror unit and/or to the drive unit on a rear side of the scanner unit facing away from the optical space. This option is particularly advantageous when the scanner unit is used in a multi-kilowatt laser machining system.

The scanner mirror including the mirror mount and the drive unit can, for example, be designed as described in EP4000789A2, wherein the magnet pairs of the scanner drive are preferably arranged on the mirror mount.

The seal element can preferably have a wave-shaped cross-section. The wave-shaped cross-section can reduce the deformation stiffness of the seal element, which can also be referred to as a seal membrane. In this way, the resistance when the mirror unit is tilted can be reduced and the dynamics of the scanner unit can be improved. In particular, the seal element can have at least one corrugation in cross-section, which is designed such that it is still present even when the mirror unit is completely deflected.

The circumferential groove of the mirror unit can preferably have a cross-section that tapers towards the groove base. In this case, the groove base refers to the deepest point of the groove, i.e., in the case of a cylindrical mirror unit, the point at which the groove has its smallest diameter. In particular, the circumferential groove can have a trapezoidal cross-section. Furthermore, the seal element can have a first thickening along the inner circumference thereof, which is formed to be complementary in shape to the groove. In the present case, this is to be understood in particular that the thickening is wedge-shaped or trapezoidal, with the outer bevels having substantially the same inclination as the outer walls of the groove. The engagement bevels of the thickening and the groove ensure an improved fit and adhesion of the snap connection between the seal element and the mirror unit. Furthermore, a trapezoidal connection form has proven to be particularly suitable with regard to the desired mass reduction.

It can be particularly advantageous if the first thickening of the seal element has a greater width than the groove in the groove base. This ensures that the seal element engages or snaps into the groove with precision.

Furthermore, it can be preferred that an inner circumference of the seal element in a relaxed state is smaller, in particular smaller by at least 2% and/or by at most 20%, than a circumference of the groove in the groove base. For example, the inner circumference of the seal element can be approximately 10% smaller than the circumference of the groove base. In this way, the seal element, when installed in the scanner unit, is under tension along the inner circumference of the seal element and is pressed into the groove.

The seal element can also be glued along the inner circumference thereof to the mirror unit within the groove. In particular, the thickening of the seal element along the inner circumference can be wetted with adhesive upon insertion into the groove. The bonding can further improve the adhesion of the seal element in the groove and thus the sealing effect.

The seal element can have a second thickening along the outer circumference of the seal element. The second thickening can be clamped along an inner circumference of the frame. The second thickening can, for example, have a circular cross-section. To form the clamping connection with the seal element, the frame along the inner circumference thereof can have a circumferential recess into which the second thickening can be received and secured by means of a clamping ring.

Embodiments of the invention provide a seal element for the scanner unit of a laser machining head according to one of the variants described above, in accordance with a second aspect. The seal element comprises an annular base body made of an elastic material, wherein the base body, along the inner circumference thereof, has a first, in particular trapezoidal thickening and, along the outer circumference thereof, a second, in particular circular thickening. The shape specifications of the thickenings refer to the shape of the cross-section in the circumferential direction of the base body.

In a relaxed state of the seal element, the base body can preferably have a wave-shaped cross-section. By forming at least one corrugation in the base body of the seal element, the resistance to the movement of a mirror unit with which the seal element is engaged is reduced. Particularly preferably, the base body can have in cross-section at least one corrugation with an inner radius of at least 0.5 mm and/or of at most 2 mm, preferably of about 1 mm to 1.5 mm. The corrugation can be formed in the base body either as an elevation or a depression. The corrugation should generally be as small as possible to minimize the mass of the base body. Overall, the corrugation can preferably be designed in such a way that it is just still present at maximum deformation of the base body during use in a scanner unit according to embodiments of the invention.

The base body of the seal element can preferably be made of silicone. Alternatively, the seal element can also be made of another, particularly emission free, plastic, such as polytetrafluoroethylene (PTFE, also known as Teflon) or a fluororubber (FKM). Due to its lower density compared to FKM and the resulting overall lower weight, silicone has proven to be particularly suitable for this application. Silicone also has advantages over other materials in terms of its hardness, its minimal injectable or pourable material thickness, its impact resilience, and its overall elastomeric properties.

A thickness of the base body can preferably be at least 0.2 mm and/or at most 0.8 mm, preferably about 0.6 mm.

For example, a seal element according to embodiments of the invention can be made of silicone by means of vacuum casting. The seal element can be translucent, can have a Shore A hardness of <50, in particular approximately 20, be 0.6 mm thick and/or have a mass >20 g, preferably <2 g, for example approximately 0.7 g.

Embodiments of the invention provide a laser machining head, in particular a laser cutting head, with a scanner assembly in accordance with a third aspect. The scanner assembly comprises a scanner unit with a mirror unit comprising a scanner mirror and a frame, wherein the mirror unit is movably mounted in the frame. The scanner assembly further comprises a diaphragm having a diaphragm opening, wherein the diaphragm is secured to the frame and wherein a smallest diameter of the diaphragm opening is smaller than an aperture of the scanner mirror. The diaphragm and the mirror unit are spaced apart from each other in the axial direction by a gap, wherein a minimum gap width is at most 2 mm, preferably at most 1 mm, more preferably about 0.8 mm. In this case, the axial direction means a direction parallel to the surface normal of the scanner mirror in a resting position, or a direction perpendicular to a bearing plane of the diaphragm.

The gap ensures the required freedom of movement for the mirror unit and at the same time is so small that it makes it difficult for particles to escape from the scanner device into the optical space of the laser machining head in which the scanner assembly is integrated. In other words, the diaphragm forms a labyrinth seal with the scanner unit.

The scanner mirror including the mirror mount and the drive unit can, for example, be designed as described in EP4000789A2, wherein the magnet pairs of the scanner drive are preferably arranged on the mirror mount.

The scanner assembly can be designed in particular for use in a laser cutting head and thus for guiding a laser beam with a power of several kilowatts, in particular of at least 0.3 kW, preferably of at least 4 kW, even more preferably of at least 10 kW.

To minimize the gap between the diaphragm and the mirror unit, the diaphragm can have a narrow, circumferential collar on the side thereof facing the mirror unit, in particular at the smallest opening diameter thereof, which points in the direction of the mirror unit. The collar increases the sealing effect of the labyrinth seal.

The scanner unit can in particular be designed like the scanner unit of the laser machining head according to one of the variants described above, and thus have a seal element between the frame and the mirror unit. According to this configuration, the diaphragm can additionally serve as beam protection for the seal element. A combination of seal element and diaphragm can therefore improve the longevity of the sealing function.

The scanner assembly can further comprise a cover which can be secured to a side of the frame opposite the diaphragm and which covers an opening formed by the frame of the scanner unit. The cover can preferably protrude into the frame at the rear of the mirror unit, so that a gap formed between the cover and the rear of the mirror unit has a minimum gap width of at most 3 mm, preferably at most 0.7 mm. In a configuration with a seal element, the scanner assembly forms a drive chamber of the scanner unit in which the movable drive components for the mirror unit are arranged and which is limited in the direction of the optical space by the seal element, laterally by the frame and at the rear by the cover.

The cover can be mounted laterally up to 2 mm, preferably up to a maximum of 1 mm, more preferably up to a maximum of 0.7 mm, from the mirror frame of the scanner unit. The diaphragm and/or the cover can each be made of a material with good heat conduction properties, for example a metal or a metal alloy. In particular, the diaphragm and/or the cover can be made of steel. In this way, the diaphragm and/or the cover can additionally be used as cooling elements for the scanner assembly. Due to the small distance to the mirror unit, heat can be dissipated from the mirror unit, i.e., from the scanner mirror and/or from the mirror frame, by free or forced convection.

The diaphragm and/or cover can also be connected to a cooling system, thus providing active cooling for the scanner assembly. For this purpose, for example, one or more cooling channels can be arranged in the diaphragm and/or in the cover, in which a cooling fluid can circulate.

Alternatively or additionally, a cooling gas can be circulated through the gap between the mirror unit and the cover to improve the cooling effect. The volume flow of the cooling gas must be selected so that no dynamic pressure is generated in the gap, which would negatively influence the mirror movement.

The scanner mirror can preferably comprise a mirror substrate made of a transparent material, in particular quartz glass. In this way, residual transmission of laser radiation through the scanner mirror, which is unavoidable when a laser beam hits the reflection surface, can be directed specifically to the rear of the scanner mirror. This can prevent lateral heat dissipation towards the mirror frame and the drive unit. The mirror substrate preferably has a thickness to diameter ratio of no more than 1:10. This ensures the necessary rigidity of the scanner mirror. For example, the scanner mirror can have a diameter of 25 mm and a thickness of 2.5 mm.

The scanner mirror can further comprise an oxidic interference coating.

Embodiments of the present invention according to the third aspect therefore also has significant advantages over the prior art with regard to cooling. The improved cooling reduces the susceptibility of the scanner unit to heating as the laser power increases.

The scanner assembly with seal element and cover can also have a bypass connection with a particle filter to bypass the seal element. The bypass connection can connect the drive chamber and the optical space on the other side of the seal element. The bypass connection ensures pressure equalization between the working space and the optical space and thus reduces pressure-related resistance that would otherwise complicate the movements of the mirror unit.

The scanner assembly (see third aspect of the invention) or the scanner unit without diaphragm (see first aspect of the invention) can each be arranged to be suspended in the laser machining head. In this context, a suspended arrangement describes an orientation of the scanner mirror downwards or in the direction of gravity. The suspended arrangement of the scanner assembly refers to a preferred working position of the laser machining head in which the laser beam is directed perpendicularly onto an object to be processed, in particular a metallic, plate-shaped, or tubular workpiece. With regard to particle sealing, the advantages of the embodiments of the present invention are particularly evident when the scanner assembly is arranged to be in a suspended position.

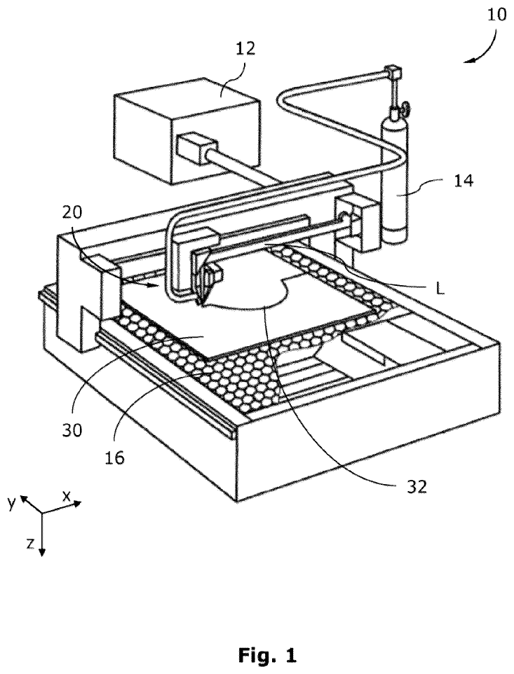

FIG. 1 shows a laser machining system in the form of a laser cutting system 10. The laser cutting system 10 comprises a laser beam source 12. The laser beam source 12 can be a CO₂ laser, a solid-state laser, or a diode laser. Even if the present representation shows a CO₂ laser configuration, in which the generated laser beam L is guided via deflecting mirrors to the laser machining head—here a laser cutting head 20—solid-state lasers, in particular disk or fiber lasers, can generally be preferred as beam sources. In solid-state lasers, the laser beam L is usually transported to the laser cutting head 20 by means of an optical fiber (not shown in FIG. 1) and fed into the laser cutting head 20 via a connection socket.

The laser cutting system 10 further comprises a cutting gas supply 14, here in the form of a gas bottle 14, via which a cutting gas, which generally contains nitrogen and/or oxygen, is transported via a line to the laser machining head 20 and is directed together with the laser beam L under a predetermined pressure through a cutting nozzle onto a workpiece 30 to be processed—here in the form of a plate. The workpiece 30 is mounted on a workpiece support 20 for processing by the processing beam consisting of laser beam L and cutting gas jet. By a relative movement between the workpiece 30 and the laser cutting head 20, the workpiece 30, which is preferably a metallic workpiece 30, is locally melted and the resulting melt is expelled downwards, so that a cutting gap 32 is created in the workpiece 30. The laser cutting system 10 further comprises a control device which is programmed to move the cutting head 20 according to a cutting contour relative to the metallic workpiece 30.

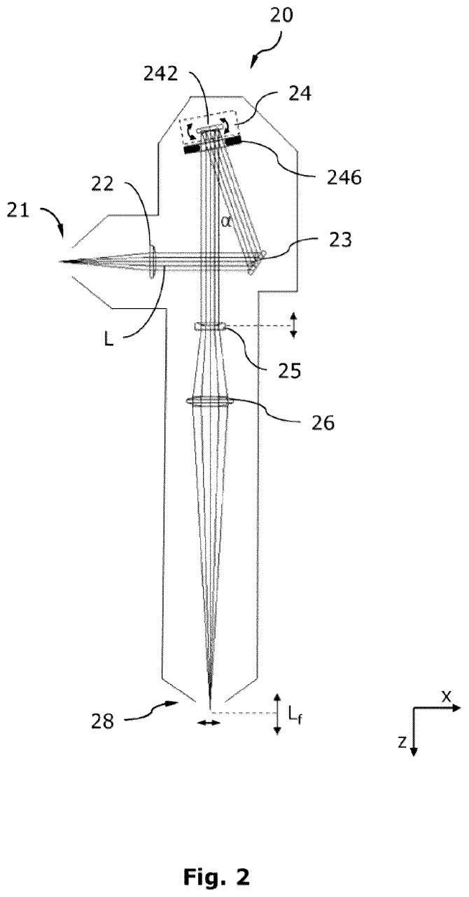

FIG. 2 shows schematically a laser cutting head 20 according to embodiments of the invention in which the optics cause a delta folding of the laser beam L. The laser beam L enters the laser cutting head 20 through an inlet opening 21. Preferably, the inlet opening 21 can be designed as a connection socket for an optical fiber cable, via which the laser beam L is transported from a laser beam source to the laser cutting head 20. The diverging laser beam L emerging from the optical fiber cable is collimated by means of a collimation device, here a collimation lens 22. The collimated laser beam L is then deflected via a deflection unit, here a deflecting mirror 23, such that it is directed at a predefined angle of incidence onto the scanner mirror 242 of a scanner assembly 24 which is arranged to be suspended in the laser cutting head 20. The scanner assembly 24 is designed to tilt the scanner mirror 242 about at least two axes of rotation in a comparatively small movement interval of up to ±2°, preferably up to ±0.3°, relative to a resting position or zero position of the scanner mirror 242.

The scanner assembly 24 includes a diaphragm 246 which is arranged in front of the scanner mirror 242. The laser beam L is deflected at the scanner mirror 242 by an angle α, which is preferably at most 60°, preferably at most 45°, even more preferably at most 30°, and is directed onto an outlet opening 28 of the laser cutting head 20. On the path to the outlet opening 28, which is preferably designed as a cutting nozzle, the laser beam L can first be widened by a widening device, here a negative lens 25, before it is focused via a focusing device, here a focusing lens 26, in the direction of the outlet opening 28, via which it leaves the laser cutting head 20 together with a cutting gas jet (not shown) and is directed as a cutting beam onto a workpiece to be processed.

By means of the controlled tilting of the scanner mirror 242, the laser beam L can be deflected very quickly in a plane (here x-y plane) transverse to the exit direction of the laser beam 242 in a predetermined movement interval within the outlet opening 28, i.e., within the cutting nozzle. The primary feed movement of the cutting beam during a cutting process can therefore be superimposed by a comparatively small and fast secondary movement of the laser beam L. Through this superimposed secondary pendulum movement or scanner movement of the laser beam L, the cutting process can be influenced in a targeted manner, for example the cutting gap can be widened in places or the cutting front inclination can be changed.

The plug socket at the inlet opening 21 of the laser cutting head 20 and/or the collimation lens 22 can be displaceable transversely to the beam path, i.e., laterally (here in the X direction). In addition, the deflecting mirror 23 can have an inclination adjustment. This allows the laser beam L to be precisely aligned to a center of the scanner mirror 242. The negative lens 25 can be mounted so as to be displaceable along the beam path (here in the Z direction). By shifting the negative lens 25 in the Z direction, the focus position L_{f} of the laser beam L can be easily changed.

A horizontal arrangement of the inlet opening 21 as shown in FIG. 2 is generally less susceptible to contamination than a vertical arrangement. Due to the horizontal arrangement of the inlet opening 21, the collimation lens 22 is also oriented so as to be mounted upright in the laser cutting head 20. A vertically arranged collimation lens 22 is also generally less susceptible to contamination, since the lens surface forms no deposit for particles in the optical space.

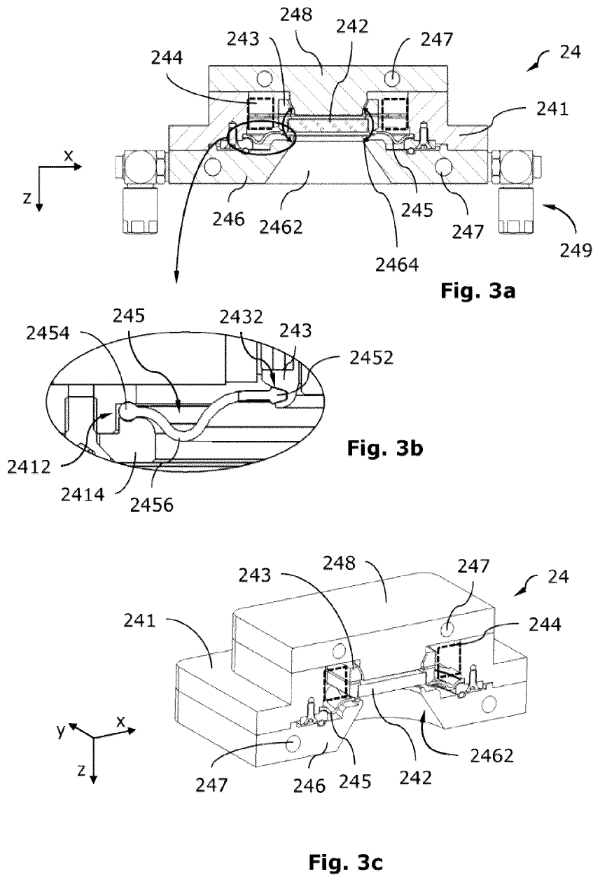

FIGS. 3a to 3c each show a scanner assembly 24 for a laser machining head according to embodiments of the invention in a sectional view. The scanner assembly 24 comprises a mirror unit with a scanner mirror 242 and a mirror mount 243. The scanner mirror 242 has a cylindrical shape and is mounted in the scanner assembly 24 together with the mirror frame 243 so as to be tiltable. For example, the mirror mount 243 can be suspended at four points evenly distributed around its circumference by a solid-state joint in a frame 241 of the scanner assembly 24. A drive unit 244 (indicated here by dashed lines) is designed to tilt the mirror mount 243 together with the scanner mirror 242 about at least two, preferably perpendicularly oriented axes of rotation at high frequency.

An annular seal element 243 made of plastic is arranged between the frame 241, which can be secured in a laser machining head 20, and the mirror unit 242. The seal element 243 has a wave-shaped cross-section with a corrugation 2456. Along the inner circumference thereof, the seal element 245 has a trapezoidal first thickening 2452, which is mounted in a likewise trapezoidal circumferential groove 2432 on the outer circumference of the mirror frame 243. Along the outer circumference thereof, the seal element 245 has a second thickening 2454, which is clamped in a circumferential recess 2412 of the frame 241 by means of a clamping ring 2414. The frame 241, the mirror unit 242 and (optionally) the seal element 243 together form a scanner unit of the scanner assembly 24.

The scanner assembly 24 further comprises a diaphragm 246 having a diaphragm opening 2462. The diaphragm opening 2462 is surrounded by a funnel-shaped inner wall of the diaphragm 246, wherein the inner wall preferably has a maximum inclination angle of 30°, preferably 22.5°, more preferably 15° with respect to a surface normal of the scanner mirror 242 (in a resting position of the scanner mirror 242). The smallest opening diameter of the diaphragm opening 2462 is smaller than the aperture of the scanner mirror 242. In this way, the mirror mount 243 can be effectively shielded by the diaphragm 246 and protected from unwanted irradiation. The diaphragm 246 has a circumferential collar 2464 that extends close to the scanner mirror 242 and serves both as a particle barrier and as beam protection.

The cover 248 is arranged on the side of the mirror unit 242 opposite the diaphragm 246, and is secured to the frame 241. Together with the frame 241, the mirror unit 242, and the seal element 243, the cover 248 defines an actuator or drive chamber of the scanner assembly. The cover 248 is designed as a heat sink 248 and projects close to the rear of the scanner mirror 242. The diaphragm 246 and the heat sink 248 are each spaced apart from the scanner mirror 242 and mirror mount 243 by a narrow gap to ensure their freedom of movement during controlled tilting. At the same time, the distances between the diaphragm 246 and the heat sink 248 to the scanner mirror 242 and the mirror frame 243 are kept as small as possible to ensure efficient heat dissipation. For example, the movements of the scanner mirror 242 during operation of the scanner assembly 24 can lead to a stroke on the outer diameter of the mirror mount 243 of +80 um. This relative movement must be taken into account when designing the gap dimensions and also when dimensioning the seal element 245 in this application.

To improve heat dissipation from the scanner mirror 242 and/or the mirror mount 243, the diaphragm 246 and the heat sink 248 are preferably made of steel or another material with good thermal conductivity properties. Furthermore, the diaphragm 246 and the heat sink 248 can be actively cooled. The latter promotes the establishment of natural convection in the small air gap. For this purpose, they can each have one or more cooling channels 247. The cooling channels 247 can be connected to a cooling circuit via cooling fluid connections 249, in which a liquid or gaseous cooling fluid flows through the cooling channels and heat is dissipated from the diaphragm 246 and/or the heat sink 248.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 Laser cutting system
12 Laser beam source
14 Cutting gas supply
16 Workpiece support
20 Laser cutting head
21 Inlet opening
22 Collimation lens
23 Deflecting mirror
24 Scanner assembly
241 Frame
2412 Recess
2414 Clamping ring
242 Scanner mirror
243 Mirror mount
2432 Groove
244 Drive unit
245 Seal element
2452 First thickening
2454 Second thickening
2456 Corrugation
246 Diaphragm
2462 Diaphragm opening
2464 Circumferential collar
247 Cooling channel
248 Cover
249 Cooling fluid connection
25 Negative lens
26 Focusing lens
28 Outlet opening
30 Workpiece
32 Cutting gap
L Laser beam
L_{f} Focus of the laser beam
α Deflection angle at the scanner mirror

1. A laser machining head comprising a scanner, the scanner comprising:
a mirror unit with a scanner mirror, the mirror unit having a groove that runs in a circumferential direction;
a frame capable of being secured in the laser machining head, the mirror unit being movably mounted in the frame; and
an annular elastic seal secured to the frame on an outer circumference of the seal and engages with the groove on an inner circumference of the seal.

2. The laser machining head according to claim 1, wherein the seal has a wave-shaped cross-section.

3. The laser machining head according to claim 1,
wherein the groove has a cross-section tapering towards a groove base, and
wherein the seal has a first thickening along the inner circumference thereof, which is configured to be complementary in shape to the groove.

4. The laser machining head according to claim 3, wherein the first thickening along the inner circumference of the seal has a greater width than the groove in the groove base.

5. The laser machining head according to claim 1, wherein the inner circumference of the seal in a relaxed state is smaller by at least 2% and/or by at most 20%, than a circumference of the groove in the groove base.

6. The laser machining head according to claim 1, wherein the seal along the inner circumference thereof is glued to the mirror unit within the groove.

7. The laser machining head according to claim 1,
wherein the seal has a second thickening along the outer circumference thereof, and
wherein the frame along an inner circumference thereof forms a clamping connection with the second thickening of the seal.

8. The laser machining head according to claim 1, wherein the seal comprises:
an annular base body made of an elastic material,
wherein the base body has a first trapezoidal thickening along the inner circumference thereof, and a second circular thickening along the outer circumference thereof.

9. The laser machining head according to claim 8, wherein the base body has a wave-shaped cross-section in a relaxed state of the seal.

10. The laser machining head according to claim 8, wherein the base body comprises silicone.

11. The laser machining head according to claim 8, wherein a thickness of the base body is at least 0.2 mm and/or at most 0.8 mm.

12. A laser machining head with a scanner assembly, the scanner assembly comprising:
a scanner with a mirror unit comprising a scanner mirror and a frame, the mirror unit being movably mounted in the frame; and
a diaphragm with a diaphragm opening,
the diaphragm being secured to the frame,
a smallest diameter of the diaphragm opening being smaller than an aperture of the scanner mirror, and
the diaphragm and the mirror unit being spaced apart from one another in an axial direction by a gap, wherein a minimum gap width is at most 2 mm.

13. The laser machining head according to claim 12, wherein the minimum gap width is at most 1 mm.

14. The laser machining head according to claim 12, further comprising:
a cover capable of being secured to a side of the frame opposite the diaphragm, wherein the cover covers an opening formed by the frame of the scanner unit.

15. The laser machining head according to claim 14, wherein the cover projects into the frame at a rear side of the mirror unit so that a gap formed between the cover and the rear side of the mirror unit has a smallest gap width of at most 3 mm.

16. The laser machining head according to claim 15, wherein the smallest gap width is at most 0.7 mm.

17. The laser machining head according to claim 12. wherein the scanner assembly is arranged to be suspended in the laser machining head.
